(19) United States
(12) Patent Application Publication
(10) Pub. No.: US 2014/0087646 A1
(43) Pub. Date: Mar. 27, 2014

(54) VEHICULAR AIR CONDITIONING APPARATUS

(71) Applicant: KEIHIN CORPORATION, Tokyo (JP)

(72) Inventors: Tsunetoshi Kitamura, Shioya-gun (JP); Tomohiro Koizumi, Shioya-gun (JP)

(73) Assignee: KEIHIN CORPORATION, Tokyo (JP)

(21) Appl. No.: 14/032,682

(22) Filed: Sep. 20, 2013

(30) Foreign Application Priority Data
Sep. 21, 2012 (JP) 2012-208944

(51) Int. Cl. B60H 1/00; B60H 1/24; B60S 1/02

(52) U.S. Cl. CPC B60H 1/00064; B60S 1/023; B60H 1/241
USPC 454/126; 454/160

(57) ABSTRACT

A vehicle air conditioning apparatus includes a case having a defrosting air outlet, a face air outlet and a foot air outlet, a mixing zone provided on a downstream side of a cold air flow path and a warm air flow path within the case and in which cold air and warm air are merged, and a face air outlet door which opens and closes the face air outlet. The face air outlet has a constantly open portion not closed by the face air outlet door. In the mixing zone, there is provided an air guide which has a warm air leading path guiding part of the warm air toward the defrosting air outlet preferentially. The air guide includes a guide wall forming the warm air leading path and having a warm air outlet which causes part of the warm air to flow toward the constantly open portion.

The present application claims priority under 35 U.S.C. §119 to Japanese Patent Application No. 2012-208944 with a filing date of Sep. 21, 2012. The contents of this application are incorporated herein by reference in their entirety.

### TECHNICAL FIELD

The present disclosure relates to a vehicle air conditioning apparatus.

### DESCRIPTION OF THE RELATED ART

In general, in a vehicle air conditioning apparatus, the supplied air is caused to become cold air by being cooled by an evaporator as a cooling unit, and conditioned air is generated by adjusting the heating ratio of the cold air.

More specifically, the vehicle air conditioning apparatus includes a case which also forms an air flow path therein while forming its outer shape. Two flow paths, i.e. a cold air flow path and a warm air flow path are provided inside the case, and a heater core as a heating unit is provided in the warm air flow path. Further, in the vehicle air conditioning apparatus, by adjusting the supply amount of cold air to the warm air flow path provided with this heater core, the heating ratio of the cold air is adjusted as described above.

However, the vehicle air conditioning apparatus includes a plurality of air outlets, i.e. a defrosting air outlet, a face air outlet and a foot air outlet. And, by blowing out the adjusted air (conditioned air) from each air outlet to the target location, a comfortable feeling is given to the passenger, or the mist on the glass window is removed.

For example, the face air outlet is configured to blow out the conditioned air to a side window via a side bent duct so as to remove the fog on the side window, while blowing out the conditioned air to the face of the passenger via a center bent duct. Herein, the conditioned air blown out to the side window is blown out by a constantly open portion provided at the face air outlet. Therefore, even when the conditioned air is not blown out to the face of the passenger, the conditioned air is blown out to the side window. Further, the foot air outlet is configured to blow out the warm air (conditioned air) to the feet of the passenger via a duct.

However, especially in a heating mode of blowing out the conditioned air to the feet through the foot air outlet, the temperature difference between the conditioned air to the feet and the conditioned air blown out from the face air outlet to the side window becomes larger, and this may make the passenger feel uncomfortable. This is because the face air outlet is generally located directly opposite to the cold air flow path, and the conditioned air blown out from the face air outlet to the side window contains therein more cold air from the cold air flow path, and in contrast, the foot air outlet is likely to contain therein more warm air from the warm air flow path. Therefore, the temperature difference between the conditioned air blown out to the side window and the conditioned air blown out to the feet becomes larger.

Under such a background, in Patent Literature 1 below, the temperature of the conditioned air blown out from said constantly open portion of the face air outlet is controlled with respect to the air supply mode, forming a dedicated warm air bypass path.

Further, in Patent Literature 2 below, a guide is provided in an air mixing door with a single support plate shape, so as to perform control.

Further, in Literature 3 below, in order to miniaturize the air conditioning apparatus, a sliding door is adopted as the air mixing door.

### PATENT LITERATURES

[Patent Literature 1] Japanese Patent Laid-Open No. 2007-76575
[Patent Literature 2] Japanese Patent Laid-Open No. 2007-83751
[Patent Literature 3] Japanese Patent Laid-Open No. 2011-105174

### SUMMARY

However, forming the dedicated warm air bypass path in the case as in Patent Literature 1, or providing the guide as in Patent Literature 2, leads to not only larger size of the case, but also undesired air supply to the constantly open portion even in the air supply mode in which the air supply to the constantly open portion is unnecessary.

Furthermore, in the technique disclosed in Patent Literature 3, the sliding door is adopted as the air mixing door so as to compact the air conditioning apparatus, so it is not possible to form the guide as in the case of the door with a single support shape. Therefore, it is necessary to form in the case a mechanism for controlling the air supply temperature of the constantly open portion, resulting in complicated mold for manufacturing the case.

The present disclosure has been made in view of the above mentioned circumstances, and provides the following vehicle air conditioning apparatus. This vehicle air conditioning apparatus suppresses the increase of temperature difference between the conditioned air to the feet and the conditioned air blown out from the face air outlet to the side window, in the heating mode of blowing out the conditioned air to the feet from the foot air outlet, and reduces the possibility that the passenger feels uncomfortable.

According to one aspect, a vehicle air conditioning apparatus includes a case, a mixing zone and a face air outlet door, the case having an air flow path and a defrosting air outlet, a face air outlet and a foot air outlet which communicate with the air flow path, the mixing zone in which cold air and warm air are merged being provided on a downstream side of a cold air flow path and a warm air flow path in the air flow path within the case, cold air cooled by a cooling unit flowing through the cold air flow path, and warm air heated by a heating unit flowing through the warm air flow path, the face air outlet door opening and closing the face air outlet.

The face air outlet has a constantly open portion which is not closed by the face air outlet door. In the mixing zone, there is provided an air guide which has a warm air leading path guiding part of the warm air toward the defrosting air outlet preferentially, and in the warm air leading path, on a guide wall forming the warm air leading path, there is provided a warm air outlet which causes part of the warm air flowing through the warm air leading path to flow toward the constantly open portion.

Further, in the vehicle air conditioning apparatus, it is preferable that on a downstream side of the cooling unit of the cold air flow path, there are formed a heating opening which communicates with the warm air flow path and a cold air opening which communicates with the mixing zone, and the vehicle air conditioning apparatus includes a sliding door which adjusts an opening ratio between the heating opening and the cold air opening by sliding between the heating opening and the cold air opening.

Further, in the vehicle air conditioning apparatus, it is preferable that the constantly open portion is formed by a notch window which is formed by removing part of the face air outlet door.

Further, in the vehicle air conditioning apparatus, it is preferable that on the face air outlet door, in a manner of being opposite to a flowing direction of the cold air passing through the mixing zone in a state that the face air outlet door is closed, a first windbreak part is provided on an upstream side in the flowing direction of the cold air on the periphery of the notch window.

Further, in the vehicle air conditioning apparatus, it is preferable that the warm air outlets are provided respectively on side guide walls provided on both sides of the air guide, the notch windows are formed on positions of the face air outlet door, corresponding to both sides in a width direction of the face air outlet respectively, and on the face air outlet door, a second windbreak part is provided on a central portion in a width direction of the face air outlet on the periphery of the notch window in a state that the face air outlet door is closed.

Further, in the vehicle air conditioning apparatus, it is preferable that the warm air outlet is provided on a central guide wall provided on a central portion of the air guide, the notch window is formed on a position of the face air outlet door, corresponding to a central portion in a width direction of the face air outlet, and on the face air outlet door, a second windbreak part is provided on an outer side in a width direction of the face air outlet on the periphery of the notch window in a state that the face air outlet door is closed.

According to one aspect of the vehicle air conditioning apparatus, in the mixing zone, there is provided an air guide which has a warm air leading path for preferentially guiding part of the warm air toward said defrosting air outlet. In the warm air leading path, on the guide wall which forms this warm air leading path, there is provided a warm air outlet which causes part of said warm air flowing through this warm air leading path, to flow toward said constantly open portion. Therefore, by mixing part of the warm air blown out from the warm air outlet, into the cold air flowing toward the constantly open portion, the temperature of the conditioned air blown out from said constantly open portion is increased. Thus, in the heating mode of blowing out the conditioned air to the feet through the foot air outlet, since the temperature of the conditioned air blown out to the side window from said constantly open portion of the face air outlet is increased, the temperature difference thereof with the conditioned air of the side window becomes smaller, reducing the possibility that the passenger feels uncomfortable.

### BRIEF DESCRIPTION OF THE DRAWINGS

FIG. 1 is a sectional view showing a schematic configuration of a first embodiment of a vehicle air conditioning apparatus.

FIG. 2(a) is a perspective view of an air guide viewed from the opposite side to a cold air opening, and FIG. 2(b) is a perspective view of a face air outlet door viewed from the inner side of the face air outlet door.

FIGS. 3(a) and (b) are a diagram showing a second embodiment of the vehicle air conditioning apparatus respectively, FIG. 3(a) is a perspective view of the air guide viewed from the opposite side to the cold air opening, and FIG. 3(b) is a front view of the face air outlet door viewed from the inner side of the face air outlet door.

FIG. 4(a) to FIG. 4(f) are a perspective view showing a modification of a windbreak member formed on the periphery of a notch window, respectively.

### DESCRIPTION OF THE EMBODIMENTS

An embodiment of a vehicle air conditioning apparatus will be described hereinafter with reference to the accompanying drawings. Incidentally, in the following drawings, the scale of each component is suitably changed to make each component recognizable.

### First Embodiment

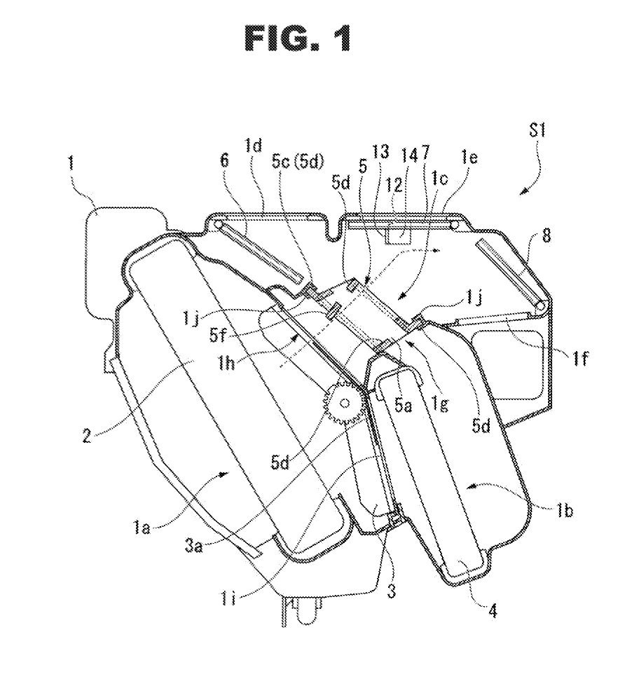

FIG. 1 is a sectional view showing a schematic configuration of a vehicle air conditioning apparatus 51 (HVAC: Heating Ventilation AirConditioning) of the present embodiment. As shown in this figure, the vehicle air conditioning apparatus 51 of the present embodiment includes a case 1, an evaporator 2, an air mixing damper apparatus 3, a heater core 4, an air guide 5, a defrosting air outlet door 6, a face air outlet door 7 and a foot air outlet door 8.

The case 1 forms the outer shape of the vehicle air conditioning apparatus S1 of the present embodiment, and has therein a cooling flow path 1a, a heating flow path 1b and a mixing portion (mixing zone) 1c. An evaporator 2 is provided in the cooling flow path 1a. In the heating flow path 1b, there is provided a heater core 4 which is arranged closer to the rear side of the vehicle than the evaporator 2. The mixing portion (mixing zone) 1c mixes the cold air and the warm air to form a conditioned air. Herein, it is assumed that the flow path in which the cold air (cooled air) flows from the cooling flow path 1a directly into the mixing portion 1c is a cold air flow path, and the flow path in which the warm air (heated air) flows from the heating flow path 1b into the mixing portion 1c is a warm air flow path (as described below). Further, in the cooling flow path 1a, there is formed an intake (not shown) which takes in an air flow blown out from a ventilator (not shown) such as a blower.

In the case 1, there are formed a plurality of air outlets which are exposed to the outside and connect to the mixing portion 1c, i.e. the defrosting air outlet 1d, the face air outlet 1e and the foot air outlet 1£ The defrosting air outlet 1d is an opening for supplying the conditioned air to a window via a duct (not shown). The face air outlet 1e is an opening for blowing out the conditioned air to a side window via a side bent duct while supplying the conditioned air to the face of the passenger via a center bent duct (not shown). The foot air outlet 1f is an opening for supplying the conditioned air to the feet of the passenger via a duct (not shown).

In addition, inside the case 1, there are provided a warm air opening 1g for supplying the warm air to the mixing portion 1c from the heating flow path 1b provided with the heater core 4, a cold air opening 1h for supplying the cold air to the mixing portion 1c from the cooling flow path 1a provided with the evaporator 2 and a heating opening 1i for supplying the cold air from the cooling flow path 1a to the heating flow path 1b. The warm air opening 1g forms the warm air flow path for blowing out the warm air from the heating flow path 1b to the mixing portion 1c as described above. In addition, the cold air opening 1h forms the cold air flow path in which the cold air flows in directly from the cooling flow path 1a toward the mixing portion 1c as described above.

The evaporator 2 is part of a refrigeration cycle mounted in the vehicle, and is arranged inside the cooling flow path 1a. The evaporator 2 cools the air supplied into the cooling flow path 1a by the ventilator (not shown), to generate the cold air.

The air mixing damper apparatus 3 is arranged on the downstream side of the evaporator 2, and adjusts the supply amount of the cold air to the heating flow path 1b, generated by the evaporator 2. More specifically, the air mixing damper apparatus 3 includes an air mixing damper 3a which is constituted by a sliding door slidable between the cold air opening 1h and the heating opening 1i. By adjusting the opening ratio of the cold air opening 1h and the heating opening 1i by this air mixing damper 3a, the supply amount of the cold air to the heating flow path 1b is adjusted. As a result, by adjusting the mixing ratio of cold air and warm air in the mixing portion 1, the temperature of the conditioned air is adjusted.

The heater core 4 is arranged inside the heating flow path 1b, and generates heated air, i.e. warm air, by heating the cold air supplied via the heating opening 1i.

The air guide 5 is arranged in the mixing portion 1c which is a mixing zone of warm air and cold air inside the case 1, and guides the warm air flowing through the warm air flow path formed by the warm air opening 1g.

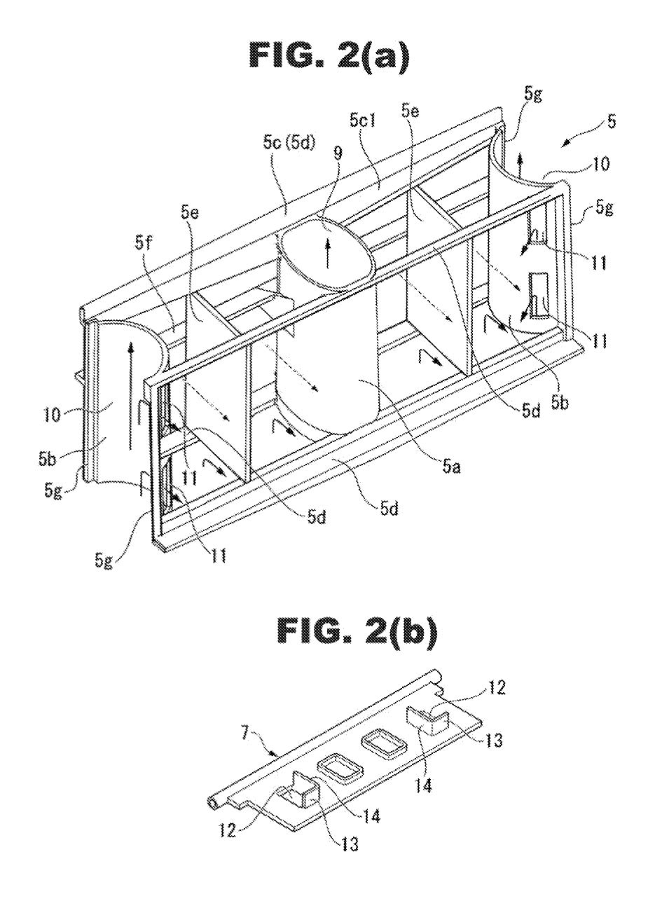

FIG. 2(a) is a perspective view of the air guide 5 viewed from the opposite side to the cold air opening 1h. As shown in this figure, the air guide 5 as a whole is a substantially rectangular parallelepiped, and is constituted by a warm air guide tube 5a, a warm air guide part 5b, an adjustment plate 5c, a support plate 5d, a rectifying board 5e, a rectifying plate 5f and a locking portion 5g.

The warm air guide tube 5a is a central guide wall, and is formed and arranged on the central portion in the width direction of the air guide 5. That is, the warm air guide tube 5a is located on the central portion in a direction perpendicular to the plane of drawing in FIG. 1, and is of a substantially rectangular tubular shape. As shown by solid arrows in FIG. 2(a), the warm air guide plate tube 5a is a straight tubular part which dose not mix part of the warm air supplied from the warm air opening 1g to the mixing portion 1c, with the cold air in the mixing portion 1c, but guides part of this warm air preferentially to the defrosting air outlet 1d. The warm air guide tube 5a is configured such that the opening of one end connects to the warm air opening 1g, and the opening of the other end faces toward the defrosting air outlet 1d. Based on such a configuration, the warm air guide tube 5a forms therein the warm air leading path 9. In addition, the warm air guide tube 5a may also be configured to take part of the cold air into the warm air leading path 9.

The warm air guide part 5b is a side guide wall, and is formed and arranged on both sides in the width direction of the air guide 5, that is, on both sides in the direction perpendicular to the plane of drawing in FIG. 1. As shown in FIG. 2(a), this warm air guide part 5b is a part with an arc plate shape that forms a flow path with the inner surface of the case 1 therebetween. The warm air guide part 5b does not mix part of the warm air supplied from the warm air opening 1g to the mixing portion 1c, with the cold air in the mixing portion 1c, but guides part of this warm air preferentially to the defrosting air outlet 1d. The warm air guide part 5b is configured such that one end connects to the warm air opening 1g, and the other end faces toward the defrosting air outlet 1d. Based on such a configuration, the flow path between the warm air guide part 5b and the inner surface of the case 1 is set as the warm air leading path 10. In addition, this warm air guide 5b may also be configured to take part of the cold air into this warm air leading path 10.

The adjustment plate 5c causes the flow direction of the cold air supplied from the cold air opening 1h to the mixing portion 1c to tend toward the warm air opening 1g, and the area 5c1 on the opposite side to the cold air opening 1h is inclined toward the warm air opening 1g.

In addition, the adjustment plate 5c can function as a support plate 5d which serves as a frame for the air guide 5 to support the shape of its own. That is, in the vehicle air conditioning apparatus S1 of the present embodiment, the adjustment plate 5c is integrated with one support plate 5d.

As described above, the support plate 5d functions as a frame by which the air guide supports the shape of it own. Including the support plate integrated with the adjustment plate 5c, these support plates 5d are connected with each of the four corners of the warm air guide tube 5a. Further, as shown in FIG. 2(a), the support plates 5d and the adjustment plate 5c are arranged in parallel to each other, in a manner of being as the four long sides forming the rectangular parallelepiped-shaped air guide 5. And, the support plate 5d integrated with the adjustment plate 5c is arranged at the upper end of the cold air opening 1h.

Further, as shown in FIG. 1, at the upper end of the cold air opening 1h and at the end of the warm air opening 1g that is farther from the cold air opening 1h, fitting grooves 1j extending in the direction perpendicular to the plane of drawing respectively are formed. And, by fitting the adjustment plate 5c and the support plate 5d in said fitting grooves 1j, the position of the air guide 5 is determined.

As shown in FIG. 2(a), the rectifying board 5e is arranged between the warm air guide tube 5a and the warm air guide part 5b, and is held by the support plate 5c. The rectifying board 5e also controls the flowing of the warm air from the warm air opening 1g indicated by solid arrows in FIG. 2(a), while controlling the flowing of the cold air from the cold air opening 1h indicated by dotted arrows in FIG. 2(a), and rectifies this cold air and warm air. Thus, by the rectification of the rectifying board 5e, the cold air and the warm air are mixed to form a mixed flow (conditioned air), and then flow toward the defrosting air outlet 1d, the face air outlet 1e and the foot air outlet 1f shown in FIG. 1.

At this time, the cooling opening 1h faces toward the face air outlet 1e. Thus, as indicated by dotted arrows of FIG. 1, the cold air flow path is directed toward the face air outlet 1e, thus said conditioned air (mixed flow) is also easily directed toward the face air outlet 1e. That is, since part of the warm air from the warm air opening 1g flows into the warm air guide tube 5a or the warm air guide part 5b, and is directly guided toward the defrosting air outlet 1d, the warm air flowing in between this warm air guide tube 5a and the warm air guide part 5b is reduced, and accordingly, the amount of the cold air between the warm air guide tube 5a and the warm air guide part 5b increases.

As shown in FIG. 2(a), the rectifying plate 5f is horizontally arranged on the cold air opening 1h side, and suppresses the formation of vortex by rectifying the cold air that is supplied from the cold air opening 1h to the mixing portion 1c, thus suppressing the generation of wind noise.

The locking portion 5g fixes the air guide 5 relative to the case 1, by being locked on the case 1.

Further, in the present embodiment, on said warm air guide part 5b, there is formed a warm air outlet 11 which causes part of the warm air flowing through each warm air leading path 10 to flow toward the constantly open portion of the face air outlet 1e. The warm air outlet 11 is of an elongated slit shape, and is formed and arranged to, by causing part of the warm air to flow toward the constantly open portion of the face air outlet 1e as described above, cause this warm air to flow from the cold air flow path formed by said cooling opening 1h toward the constantly open portion of the face air outlet 1e via the air guide 5. That is, the warm air outlet 11 is formed on the opposite side to the cold air opening 1h, and by causing the blown out warm air to be merged and mixed with the cold air flowing toward the constantly open portion, increases the temperature of the cold air (conditioned air) flowing into the constantly open portion. Further, in the present embodiment, in each warm air guide part 5b, the warm air outlets 11 are formed on the upstream side and downstream side of the warm air leading path 10, respectively. The longitudinal direction of the slit is configured to be consistent with the flowing direction of the warm air leading path 10.

Returning to FIG. 1, the defrosting air outlet door 6 is a damper that is arranged on the inner side of the defrosting air outlet 1d and controls the opening and closing of the defrosting air outlet 1d, and is configured to be rotatable within the case 1.

The face air outlet door 7 is a damper that is arranged on the inner side of the face air outlet 1e and controls the opening and closing of the face air outlet 1e, and is configured to be rotatable within the case 1.

The foot air outlet door 8 is a damper that is arranged on the inner side of the foot air outlet 1f and controls the opening and closing of the foot air outlet 1f, and is configured to be rotatable within the case 1.

Herein, the face air outlet door 7 is configured to be capable of covering and causing the whole face air outlet 1e formed in a rectangular shape to open and close. As shown in FIG. 2(b) of the perspective view of this face air outlet door 7 viewed from the inner side of the face air outlet door 7, the face air outlet 1e as a whole is formed in a substantially rectangular shape. And, in the present embodiment, on both sides in the width direction of the face air outlet le, that is, on the positions corresponding to both sides in the longitudinal direction (width direction) of the rectangular-shaped face air outlet 1e, there is formed a rectangular-shaped notch window 12 respectively, which is formed by removing of part of the face air outlet door 7.

Thus, by forming two notch windows 12 on the face air outlet door 7, the portions in the face air outlet 1e corresponding to said notch windows 12 become the constantly open portions. That is, the opening and closing of the face air outlet 1e is controlled by the opening and closing of the face air outlet door 7, but the portions corresponding to said notch windows 12 are open either case, when the face air outlet door 7 is opened or when the face air outlet door 7 is closed. Therefore, these portions corresponding to the notch windows 12 are portions that are constantly open and independent of the opening and closing of the face air outlet door 7, i.e. constantly open portions.

These constantly open portions, i.e. said notch windows 12 in a state that the face air outlet door 7 is closed, are formed on the positions substantially opposite to the warm air outlet 11 indicated by FIG. 2(a), in the present embodiment. Thus, the conditioned air flowing through both sides in the width direction of the air guide 5 is easy to flow into said constantly open portions (notch windows 12). That is, in the conditioned air formed by mixing of the cold air flowing from the cold air flow path formed by said cooling opening 1h toward the face air outlet 1e through the air guide 5, with the warm air flowing from the warm air flow path formed by said warm air opening 1g to the face air outlet 1e through the air guide 5, especially the conditioned air entraining the warm air blown out from said warm air outlet 11, is easy to flow into the constantly open portions (notch windows 12).

At this time, the rectifying board 5e is formed between the warm air guide tube 5a and the warm air guide part 5b of the air guide 5, thus the flowing in the width direction is weakened. In the warm air blown out from the warm air outlet 11, more warm air to both sides in the width direction is easier to be contained, as compared with that to the central portion in the width direction.

Further, in the present embodiment, as shown in FIG. 2(b), on the periphery of the notch window 12 of the face air outlet door 7, a first windbreak part 13 is provided in a manner of being opposite to the flowing direction of the cold air (conditioned air) through said air guide 5 (mixing portion 1c) in a state that this face air outlet door 7 is closed. That is, as indicated by dotted arrows in FIG. 1, in a manner of being opposite to the direction of flowing of the cold air (conditioned air) flowing through the cold air flow path formed by said cold air opening 1h, the first windbreak part 13 is provided on one side which is the upstream side of the flowing of the cold air (conditioned air), of the rectangular-shaped notch window 12.

Further, in the present embodiment, in a state that the face air outlet door 7 is closed, on the central portion in the width direction of the face air outlet le, on the periphery of the notch window 12 (on the central portion in the width direction of the face air outlet door 7), that is, on one side which is closer to the central portion, of the rectangular-shaped notch window 12, a second windbreak part 14 is provided. Thus, in the present embodiment, the two adjacent sides of the rectangular-shaped notch window 12 form the first windbreak part 13 and the second windbreak part 14 in a manner of connection at a right angle.

The first windbreak part 13 and the second windbreak part 14 are integrated with the face air outlet door 7, and the heights of these windbreak parts can be appropriately determined according to the size of the notch window 12 and the specification of the vehicle air conditioning apparatus S1, etc.

In addition, the air mixing damper apparatus 3, the defrosting air outlet door 6, the face air outlet door 7 and the foot air outlet door 8 perform sliding operation or opening and closing operation by a motor not shown.

Further, in the present embodiment, the face air outlet 1e is configured to communicate with one end of the center bent duct (not shown), on the position corresponding to the central portion in the width direction thereof (i.e., the central portion in the width direction of the face air outlet door 7 shown in FIG. 2(b)), and to communicate with one end of the side bent duct (not shown), on the positions corresponding to both sides in the width direction respectively. Thus, the constantly open portions formed by the notch window 12 on both sides in the width direction of the face air outlet 1e, are arranged opposite to one end of the side bent duct (not shown), respectively.

According to the vehicle air conditioning unit S1 of the present embodiment having this configuration, the cold air opening 1h and the heating opening 1i both are caused to open by the air mixing damper apparatus 3, thus the air supplied to the cooling flow path 1a is cooled by the evaporator 2 and becomes the cold air, and part of this cold air is supplied to the heating flow path 1b.

Further, the warm air generated by being heated by the heater core 4 in the heating flow path 1b, flows through the warm air flow path from the warm air opening 1g and is supplied to the mixing portion 1c, and the cold air which is not supplied to the heating flow path 1b flows through the cold air flow path from the cold air opening 1h and is supplied to the mixing portion 1c.

The cold air and the warm air supplied to the mixing portion 1c are guided to the air guide 5 and mixed, and are supplied into the vehicle via the opened one of the defrosting air outlet 1d, the face air outlet 1e and the foot air outlet 1f.

Herein, in the vehicle air conditioning apparatus S1 in the present embodiment, the air guide 5 includes the warm air guide tube 5a and the warm air guide part 5b. This warm air guide tube 5a guides part of the warm air without mixing it with the cold air in the mixing portion 1c. Thus, especially toward the defrosting air outlet 1d, the warm air having a higher temperature can be blown out.

Further, since the warm air outlet 11 is formed on the warm air guide part 5b, part of the warm air flowing through the warm air leading path 10 formed by this warm air guide part 5b can be mixed with the cold air (conditioned air) flowing toward the constantly open portion. Thus, in a state that the face air outlet door 7 is closed, for example, the temperature of the conditioned air flowing out from said constantly open portion can increase along with the added (mixed) part of the warm air flowing through the warm air leading path 10.

Therefore, in the heating mode in which the conditioned air is blown out to the feet via the foot air outlet 1f, it is possible to increase the temperature of the conditioned air blown out from said constantly open portion of the face air outlet 1e to the side window via the side bent duct (not shown). Thus, it is possible to reduce the temperature difference between the conditioned air to the side window and the conditioned air to the feet, reducing the possibility that the passenger feels uncomfortable.

In addition, by forming the notch window 12 on the face air outlet 7, a constantly open portion is formed, thus it is possible to easily form a constantly open portion in a more appropriate position.

Further, since the first windbreak part 13 is provided on the periphery of the notch window 12, it is possible to suppress flowing into the constantly open portion through the notch window 12, of the cold air flowing through the cold air flow path formed by the cold air opening 1h. In this way, since it is possible to cause the conditioned air containing the warm air blown out from the warm air outlet 11 to flow into the constantly open portion preferentially, the temperature of the conditioned air blown out from the constantly open portion can be increased.

Further, since the second windbreak part 14 is provided on the periphery of the notch window 12, it is also possible to suppress flowing into the constantly open portion through the notch window 12, of the cold air flowing through the cold air flow path formed by the cold air opening 1h. Thus, the temperature of the conditioned air blown out from the constantly open portion can be increased.

### Second Embodiment

Next, a second embodiment of the vehicle air conditioning apparatus S1 will be described.

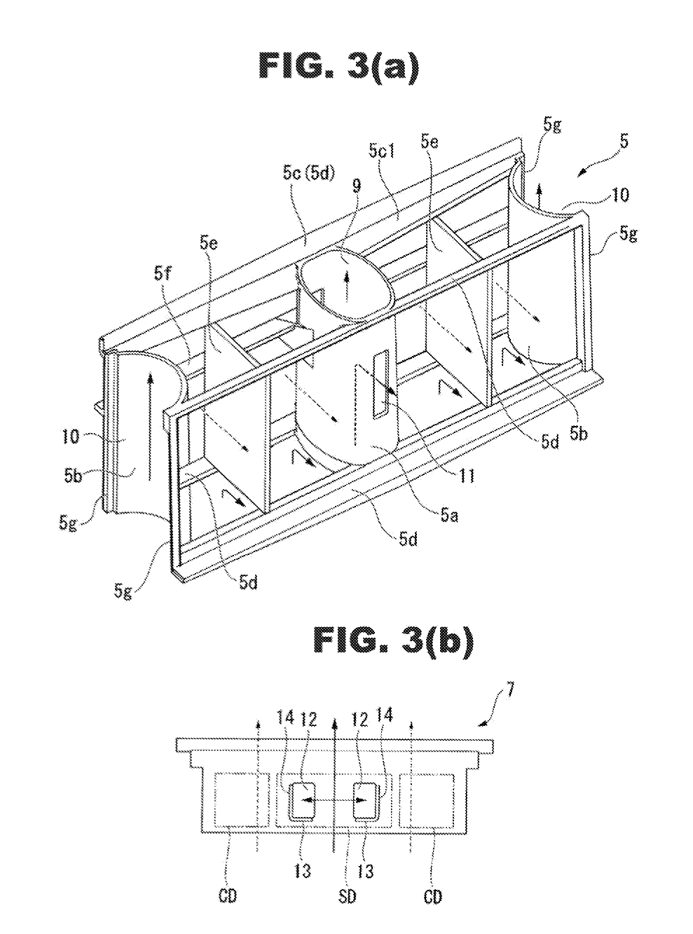

The present embodiment is different from the first embodiment in that, as shown in FIG. 3(b) showing the inner surface of the face air outlet door 7, the present embodiment is configured such that one end of the side bent duct SD communicatively disposed at the position corresponding to the central portion in the width direction of the face air outlet door 7, and one end of the center bent duct CD is communicatively disposed at the positions corresponding to both sides in the width direction, respectively.

In addition to this, in the present embodiment, the formation position of the warm air outlet 11 and the position of the constantly open portion based on the notch window 12 are different from that in the first embodiment.

That is, as shown in FIG. 3(a) of the perspective view of the air guide 5 viewed from the opposite side to the cold air opening 1h, in the present embodiment, the warm air outlet 11 is not formed on the warm air guide part 5b, and instead, the warm air outlet 11 is formed on the warm air guide tube 5a.

The warm air outlet 11 is of an elongated slit shape formed on the surface on the opposite side to the cold air opening 1h, and is formed and configured such that part of the warm air flowing through the interior of the warm air leading path 9 flows toward the constantly open portion of the face air outlet 1e. Thus, to the cold air flowing from the cold air flow path formed by said cooling opening 1h toward the constantly open portion of the face air outlet 1e through the air guide 5, part of the warm air is blown out. That is, as in the first embodiment, the warm air outlet 11 is used for causing the warm air blown out to be merged and mixed with the cold air (conditioned air) flowing toward the constantly open portion, so as to increase the temperature of the cold air flowing into the constantly open portion.

In addition, the formation position of the warm air outlet 11 is not limited to the position shown in FIG. 3(a), as long as the warm air can be caused to be merged with the cold air (conditioned air) flowing toward the constantly open portion. For example, the warm air outlet 11 can be formed on the surface facing toward one of the warm air guide parts 5b or on the surface facing toward the other warm air guide part 5b, or both of the two surfaces. In this case, the warm air blown out from this warm air outlet 11 can be caused to be merged and mixed with the cold air (conditioned air) flowing through between the warm air guide tube 5a and the rectifying board 5e.

Further, as shown in FIG. 3(b), on the face air outlet door 7, on the central portion in the width direction thereof, i.e. the central portion in the width direction of the face air outlet 1e, two adjacent notch windows 12 are formed. These two rectangular-shaped notch windows 12 are formed by removing part of the face air outlet door 7. And, as in the first embodiment, at a position of the face air outlet 1e, corresponding to the portion where this notch window 12 is formed, a constantly open portion is formed.

Here, in a state that the face air outlet 7 is closed, this notch window 12 is formed and configured to face one end of the side bent duct SD as described above. Thus, the conditioned air (mixed air) blown out through this notch window 12 and further through the constantly open portion is blown out to the side window via the side bent duct SD.

Further, in the present embodiment, on the periphery of the notch window 12 of the face air outlet door 7, a first windbreak part 13 is provided in a manner of being opposite to the flowing direction of the cold air through the air guide 5 (mixing portion 1c), in a state that this face air outlet door 7 is closed. That is, on the same one side as the first embodiment of the rectangular-shaped notch window 12, the first windbreak part 13 is provided.

Further, in the present embodiment, in a state that the face air outlet door 7 is closed, on the outer side in the width direction of the face air outlet 1e, on the periphery of the notch window 12 (on the outer side in the width direction of the face air outlet door 7), that is, on the opposite side to the adjacent notch window 12, of the rectangular-shaped notch window 12, a second windbreak part 14 is provided. Thus, in the present embodiment, the first windbreak part 13 and the second windbreak part 14 are also formed to be connected at a right angle with the two adjacent sides of the rectangular-shaped notch window 12.

The first windbreak part 13 and the second windbreak part 14 are also integrated with the face air outlet door 7, and the heights of these windbreak parts can be appropriately determined according to the size of the notch window 12 or the specification of the vehicle air conditioning apparatus 51, etc.

In the vehicle air conditioning apparatus 51 having such a configuration, the warm air outlet 11 is formed on the warm air guide tube 5a, thus part of the warm air flowing through the warm air leading path 9 formed by this warm air guide tube 5a can be mixed into the cold air (conditioned air) flowing toward the constantly open portion. Thus, in a state that the face air outlet door 7 is closed, for example, the temperature of the conditioned air flowing out from said constantly open portion can increase along with the added (mixed) part of the warm air flowing through the warm air leading path 9.

Therefore, in the heating mode in which the conditioned air is blown out to the feet via the foot air outlet 1f, it is possible to increase the temperature of the conditioned air blown out from said constantly open portion of the face air outlet 1e to the side window via the side bent duct (not shown). Thus, it is possible to reduce the temperature difference between the conditioned air to the side window and the conditioned air to the feet, reducing the possibility that the passenger feels uncomfortable.

Further, since the first windbreak part 13 is provided on the periphery of the notch window 12, it is possible to suppress flowing into the constantly open portion through the notch window 12, of the cold air flowing through the cold air flow path formed by the cold air opening 1h. In this way, since it is possible to cause the conditioned air containing the warm air blown out from the warm air outlet 11 to flow into the constantly open portion preferentially, the temperature of the conditioned air blown out from the constantly open portion can be increased.

Further, since the second windbreak part 14 is provided on the periphery of the notch window 12, it is also possible to suppress flowing into the constantly open portion through the notch window 12, of the cold air flowing through the cold air flow path formed by the cold air opening 1h. Thus, the temperature of the conditioned air blown out from the constantly open portion can be increased.

In addition, the present invention is not limited to the above embodiments, and various changes can be made within the scope not departing from the gist of the present invention.

For example, in the first embodiment, the warm air outlet 11 is formed and arranged on the opposite side to the cold air opening 1h on the warm air guide part 5b. However, the warm air outlet 11 can also be formed on another position of the warm air guide part 5b, as long as the warm air blown out from the warm air outlet 11 can be caused to flow toward the constantly open portion side. For example, the warm air outlet 11 can also be formed and arranged on a position facing the warm air guide tube 5a on the warm air guide part 5b, such that the warm air is merged with the cold air (conditioned air) flowing through the cold air flow path, to flow into the constantly open portion together.

In addition, the shape, size, quantity or the like of the warm air outlet 11 can be set appropriately. For example, as shown in FIG. 2(a), instead of forming a warm air outlet 11 on the upstream side and the downstream side of the warm air leading path 10 respectively, a warm air outlet 11 can also be formed and arranged only on the upstream side or only on the downstream side. In this case, it is preferable to, via the warm air outlet 11 shown in FIG. 2(a), extend the opening width thereof (the width in the direction perpendicular to the flowing direction of the warm air flowing through the warm air leading path 10), so as to extend the opening area thereof.

Forming the warm air outlet 11 only on the upstream side of the warm air leading path 10 and expanding the opening area of this warm air outlet 11, are sufficient to increase the amount of the warm air flowing through the constantly open portion. Thus, it is possible to further increase the temperature of the air blown out to the side window. On the other hand, forming the warm air outlet 11 only on the downstream side of the warm air leading path 10 and expanding the opening area of this warm air outlet 11, can especially increase the amount of the warm air flowing through the foot air outlet 1f. Thus, the shape, size, quality or the like of the warm air outlet 11 can be set appropriately according to the specification and so on of the vehicle air conditioning apparatus.

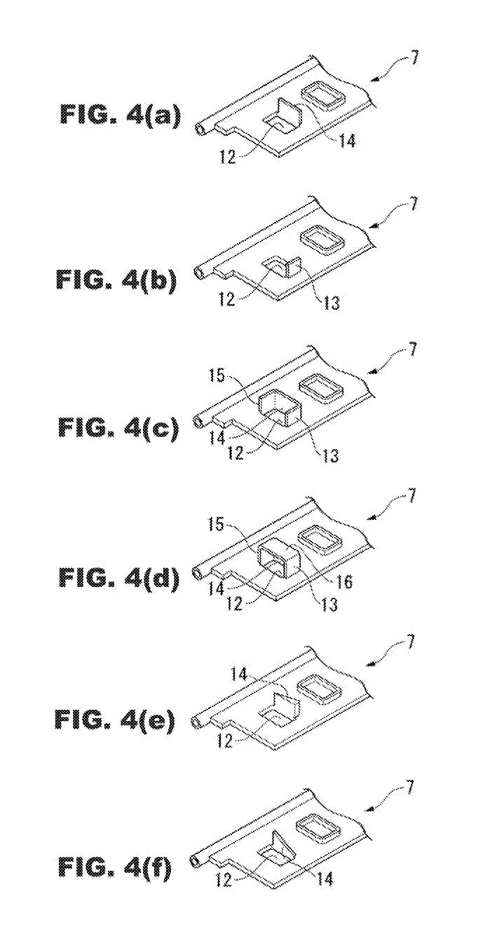

Furthermore, with regard to the windbreak part formed on the periphery of the notch window 12, it is not limited to the form shown in FIG. 2(b) or FIG. 3(b), but can adopt various forms. For example, as shown in the first embodiment, in a case that one end of the side bent duct SD is configured to be connected with the positions corresponding to both sides in the width direction of the face air outlet 1e, it is possible to form only the second windbreak part 14 as shown in FIG. 4(a), or to form only the first windbreak part 13 as shown in FIG. 4(b).

Further, the third windbreak part 15 can also be attached on the opposite side to the first windbreak part 13 as shown in FIG. 4(c). In this case, the fourth windbreak part can also be provided above the first windbreak part 13, the second windbreak part 14 and the third windbreak part 15, covering the upper portion above the notch window 12 as shown in FIG. 4(d). By this form, it is possible to more effectively prevent the cold air from flowing into the notch window 12, and to further increase the temperature of the conditioned air blown out to the side window side via the side bent duct SD.

Furthermore, as shown in FIG. 4(e), by causing the front end portion of the second windbreak part 14 to expand, it is possible to weaken the flowing momentum of the conditioned air when the conditioned air passes through the second windbreak part 14, thus suppressing the generation of noise.

Further, as shown in FIG. 4(f), the second windbreak part 14 is inclined in a manner of front end being lowered and rear end being elevated, thus it is possible to adjust the temperature of the conditioned air blown out from the constantly open portion, with this inclination angle.

Furthermore, with regard to the shape of the notch window 12, it is not limited to the rectangular shape, but may be formed to be of any shape such as a circular shape, an elliptical shape, a triangular shape or other polygonal shapes.

In addition, with regard to the warm air outlet 11, description has been given of the case of being formed on the warm air guide part 5b (the first embodiment) and the case of being formed on the warm air guide tube 5a (the second embodiment). However, the warm air outlet 11 can also be formed on both of the warm air guide part 5b and the warm air guide tube 5a, respectively.

Further, in the aforementioned embodiments, a constantly open portion is formed by the notch window 12 formed by removing part of the face air outlet door 7, but the present invention is not limited to this. For example, the face air outlet door 7 can also be formed to be smaller than the face air outlet 1e, thus forming on the face air outlet 1e a portion that can not be closed by the face air outlet door 7, and taking this portion as the constantly open portion.

We claim:

1. A vehicle air conditioning apparatus comprising:
a case, the case comprising an air flow path, and a defrosting air outlet, a face air outlet and a foot air outlet each communicating with the air flow path, and a face air outlet door opening and closing the face air outlet,
wherein the air flow path includes a cold air flow path, a warm air flow path, and a mixing zone disposed on a downstream side of the cold air flow path and the warm air flow path, wherein cold air provided through the cold air flow path and warm air provided through the warm air flow path are merged in the mixing zone,
wherein the face air outlet has a constantly open portion which is not covered by the face air outlet door when the face air outlet door is closed,
wherein the case further includes an air guide in the mixing zone, the air guide including a warm air leading path guiding a part of the warm air toward the defrosting air outlet, and
wherein the air guide includes a guide wall forming the warm air leading path, the guide wall including a warm air outlet which directs a part of the warm air flowing through the warm air leading path toward the constantly open portion of the face air outlet.

2. The vehicle air conditioning apparatus according to claim 1, further comprises a cooling unit to supply the cold air in the cold air flow path, and a heating opening and a cold air opening each disposed on a downstream side of the cooling unit, the heating opening communicating with the warm air flow path and the cold air opening communicating with the mixing zone, and
wherein the vehicle air conditioning apparatus further includes a sliding door which adjusts an opening ratio between the heating opening and the cold air opening by sliding between the heating opening and the cold air opening.

3. The vehicle air conditioning apparatus according to claim 1, wherein the constantly open portion is a notch window formed by removing part of the face air outlet door.

4. The vehicle air conditioning apparatus according to claim 3, wherein the face air outlet door includes a first windbreak part on the periphery of the notch window on an upstream side in the flowing direction of the cold air when the face air outlet door is closed, in a manner that the first windbreak part opposes the cold air passing through the mixing zone in a state that the face air outlet door is closed.

5. The vehicle air conditioning apparatus according to claim 3, wherein the air guide includes a first guide wall of the guide wall on one side thereof, and a second guide wall of the guide wall on the other side thereof, the first guide wall including a first warm air outlet of the warm air outlet and the second guide wall including a second warm air outlet of the warm air outlet,
wherein the face air outlet door includes a first notch window at a position corresponding to the first guide wall and a second notch window at a position corresponding to the second guide wall, and
wherein respective one of the first notch window and the second notch window includes a second windbreak part on the periphery thereof at a position closer to a widthwise center of the face air outlet door.

6. The vehicle air conditioning apparatus according to claim 3, wherein the air guide includes the guide wall at a widthwise center thereof,
wherein the face air outlet door includes the notch window at a position corresponding to the guide wall, and
wherein the notch window includes a second windbreak part on the periphery thereof on an outer side in the width direction of the face air outlet door.
